(19) United States
(12) Patent Application Publication
(10) Pub. No.: US 2003/0166415 A1
(43) Pub. Date: Sep. 4, 2003

(54) Gun type main game machine

(76) Inventor: David Wu, Taipei (TW)

Correspondence Address: BRUCE H. TROXELL, 5205 LEESBURG PIKE, SUITE 1404, FALLS CHURCH, VA, 22041, US

(21) Appl. No.: 10/084,949

(22) Filed: Mar. 1, 2002

(51) Int. Cl. A63F 13/00

(52) U.S. Cl. 463/37; 463/46; 463/47

(57) ABSTRACT

A gun type main game machine, the machine comprises: a light gun connecting with an image, sound and power line, the light gun is mounted therein in pursuance of the shape thereof a main electric circuit board for games, the main electric circuit board is provided with a single chip microprocessor, a microswitch, a plurality of light emitting diodes and a photoelectric diode; the shank of the light gun is provided with an exposed trigger for controlling the microswitch to activate the photoelectric diode to thereby eject light beam out of the muzzle of the light gun. In this mode, the game machine can control electric games only with the single light gun to thereby save using a conventional large main game machine.

### BACKGROUND OF THE INVENTION

1. Field of the Invention

The present invention is related to a gun type main game machine, and especially to a gun type main game machine which comprises a single light gun, the electric circuit for the main game machine is installed in the light gun, games are controlled directly by the light gun.

2. Description of the Prior Art

Among the electric games prevailing nowadays, mostly their main machines are connected respectively to power sources and displays (such as television sets). A game control device (such as a light gun) can be insertion connected to a game machine, and a user can control proceedings of games with the light gun.

FIG. 1 shows an essential allocation of such game equipment. A main machine 10 is connected to a power source through a conductor 11, and connected to a television set 13 through another conductor 12. A light gun 14 is connected to the main machine 10 through a conductor 15. Such conventional game equipment must have the light gun 14 connected to the main machine 10, it is complicated structurally, and thereby is quite inconvenient. For example, a manufacturer must wrap up for shipping the main machine 10, the light gun 14 and other accessories after production of such conventional game equipment. And sellers have to have space for storing and disposing such larger game equipment, and a consumer requires a larger room to place the game equipment he bought. Thereby, such conventional game equipment is not desirable.

### SUMMARY OF THE INVENTION

The object of the present invention is to provide a gun type main game machine, in which, an electric circuit board and related elements are installed in a light gun; and in which, a photoelectric diode in cooperation with a light guiding shade and a lens is driven by a trigger to activate a microswitch for controlling game playing. Such game equipment can thereby save a conventional main game machine to thereby save space for packaging, storage as well as placing, the volume it occupies is reduced and simplified, and this is the motive of the present invention.

The present invention will be apparent in its novelty and other characteristics after reading the detailed description of the preferred embodiment thereof in reference to the accompanying drawings.

### BRIEF DESCRIPTION OF THE DRAWINGS

FIG. 1 is a perspective view showing the structure of a set of conventional game equipment;

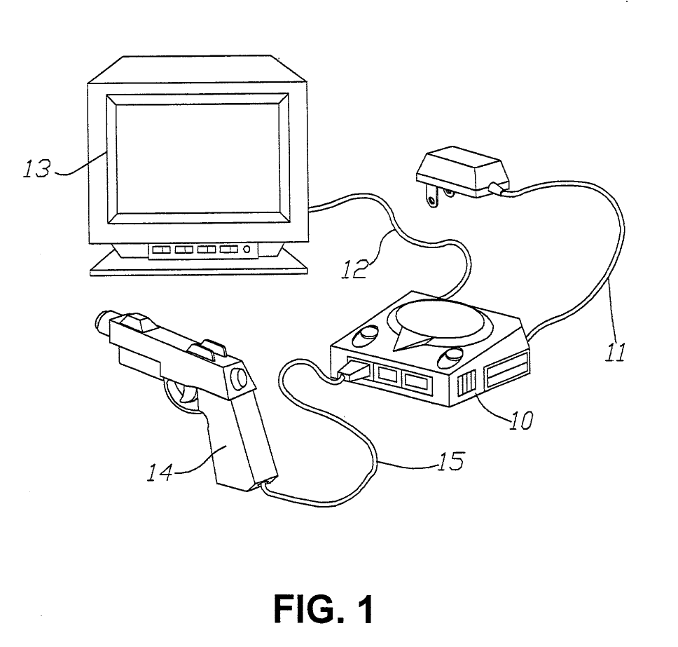

FIG. 2 is a perspective view of a preferred embodiment of the present invention;

FIG. 3 is a schematic view showing the structure of a light gun as shown in FIG. 2 of the present invention

FIG. 4 is a flow chart showing the operating process of preferred embodiment of the present invention;

FIG. 5 is a perspective view showing connecting of the present invention to a TV set;

FIG. 6 is a rear view as compared to FIG. 5;

FIG. 7 shows another preferred embodiment of the present invention.

### DETAILED DESCRIPTION OF THE PREFERRED EMBODIMENT

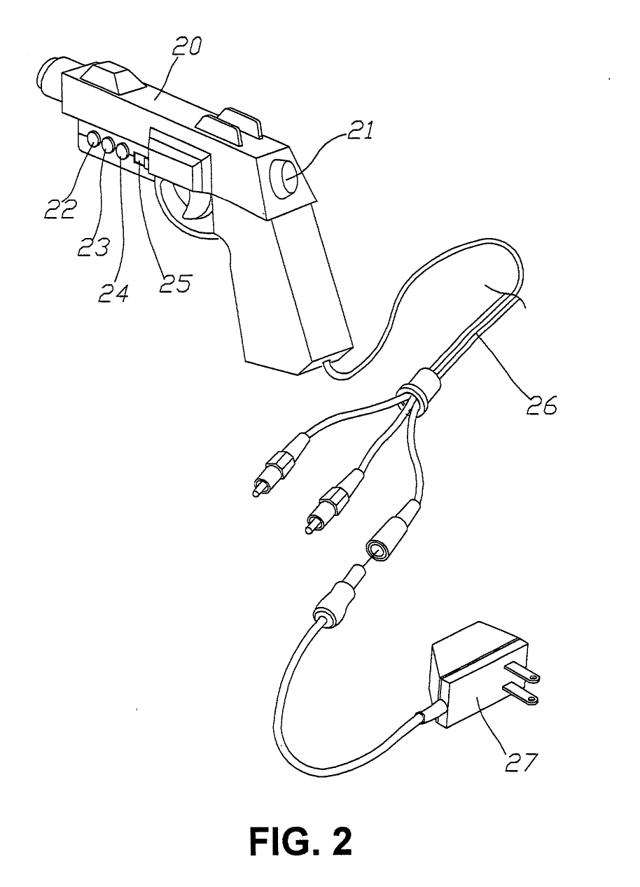

Referring to FIG. 2, the present invention is provided with a gun type main game machine saving a conventional large main game machine; it is simply a light gun 20. In the preferred embodiment shown, the light gun 20 includes a plurality of externally provided operating buttons 21, 22, 23, 24 and a power switch 25. The preferred embodiment is also provided on the bottom of the stock with an image, sound and power line 26. This embodiment is connected to the power source by means of an externally insertion connected transformer 27, by all means, the light gun 20 can also be supplied with electric power from a battery.

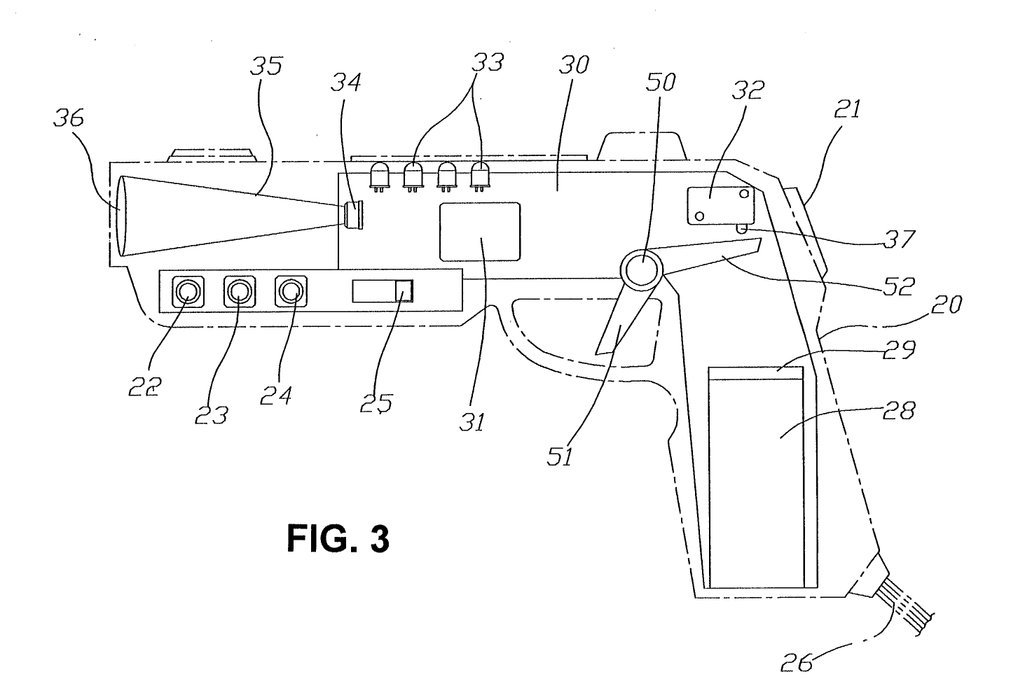

As shown in FIG. 3, the present invention can be mounted therein a main electric circuit board 30 for games, the main electric circuit board 30 is provided with a single chip microprocessor 31, a microswitch 32, a plurality of light emitting diodes 33 and a photoelectric diode 34 etc. In the preferred embodiment, the photoelectric diode 34 can be provided on the front end thereof with a light guiding shade 35, and can be provided on the front end of the light guiding shade 35 with a lens 36 near the gun muzzle.

The shank of the gun is provided with a trigger 50 which has a backwardly movable triggering end 51 and a moving end 52. The microswitch 32 is located at a place slightly above the moving end 52, so that when the triggering end 51 of the trigger 50 is pressed inwardly, the moving end 52 will contact a control button of the microswitch 32.

And in the preferred embodiment shown, the shank of the gun is provided therein near the stock with an extension groove 28 to receive a connecting means 29. In this way, other extension cards or game software can be mounted therein when being in necessity.

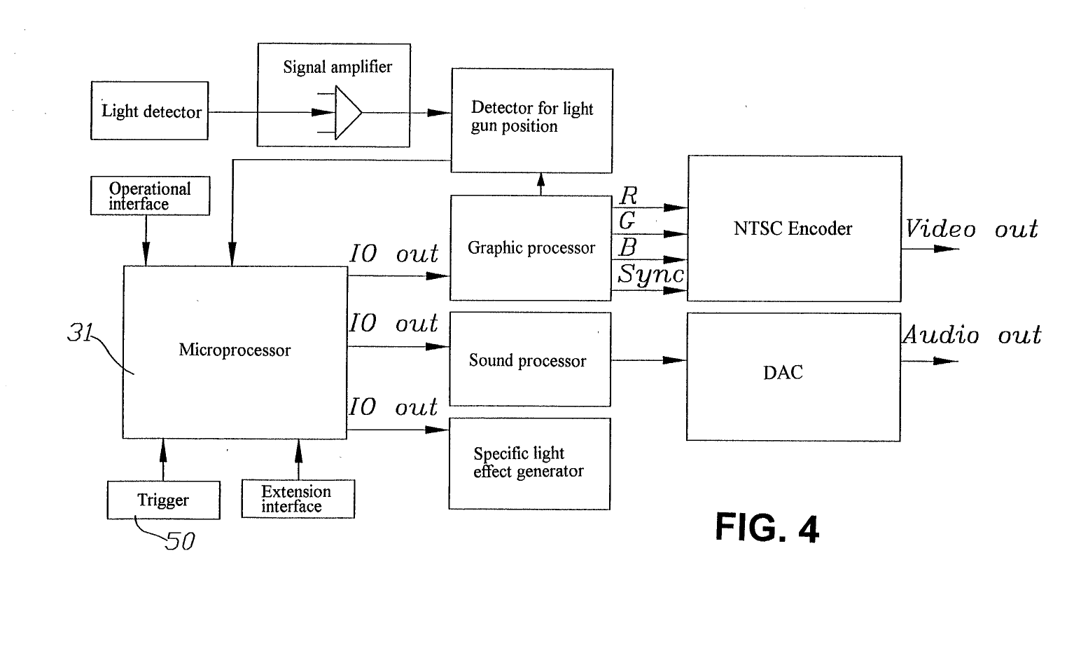

As shown in FIG. 4, when the trigger 50 of the light gun 20 of the present invention has been pressed, the microprocessor 31 converts the graphic signals into image signals for outputting after graphic processing, sound processing in cooperation with adding of light effect and detecting the position of the light gun 20 by a light detector, then the acoustic digital signals are changed into analog signals for outputting.

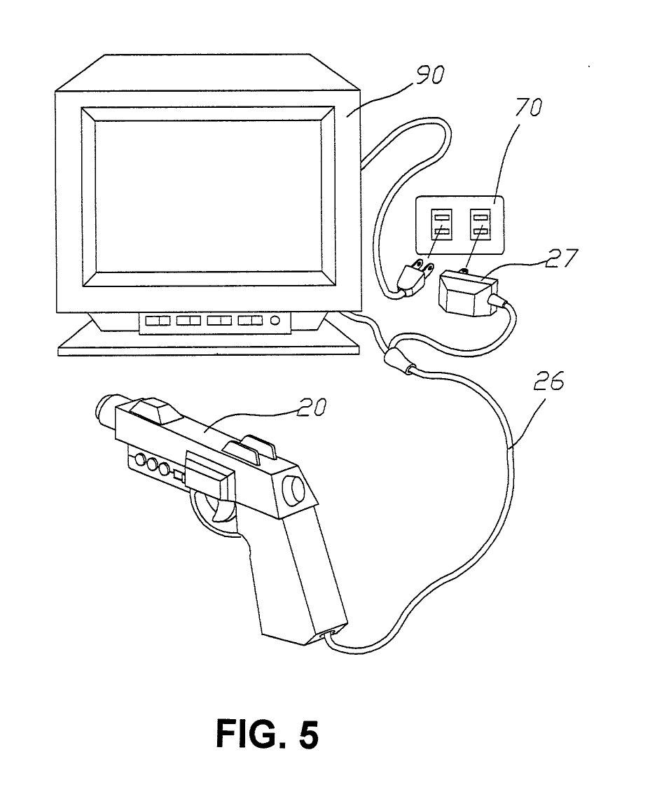

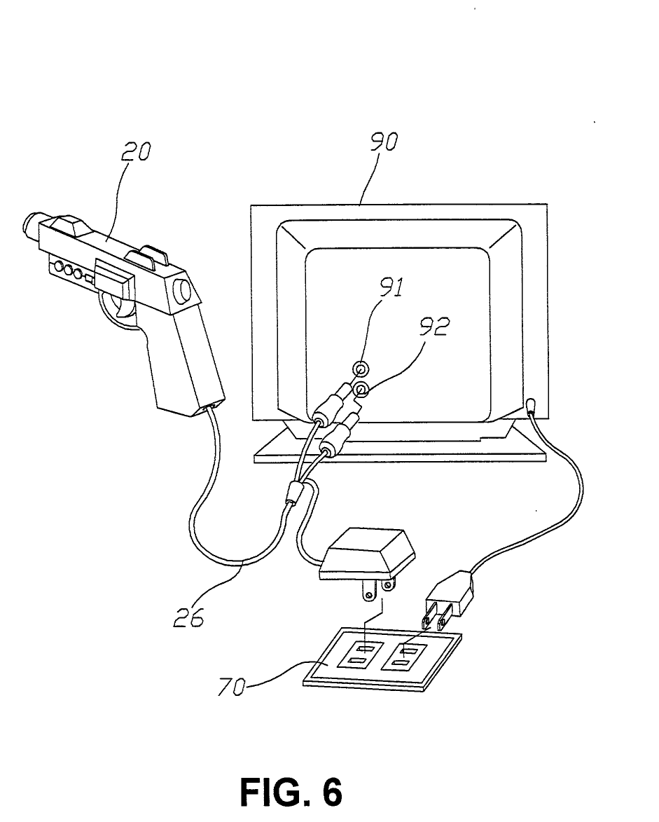

Referring to FIGS. 5 and 6, the image, sound and power line 26 of the light gun 20 of the present invention can be connected respectively to a power supply socket 70 and an image and a sound socket 91, 92 of a displaying device (such as a TV set), and games can proceed just under control of the light gun 20.

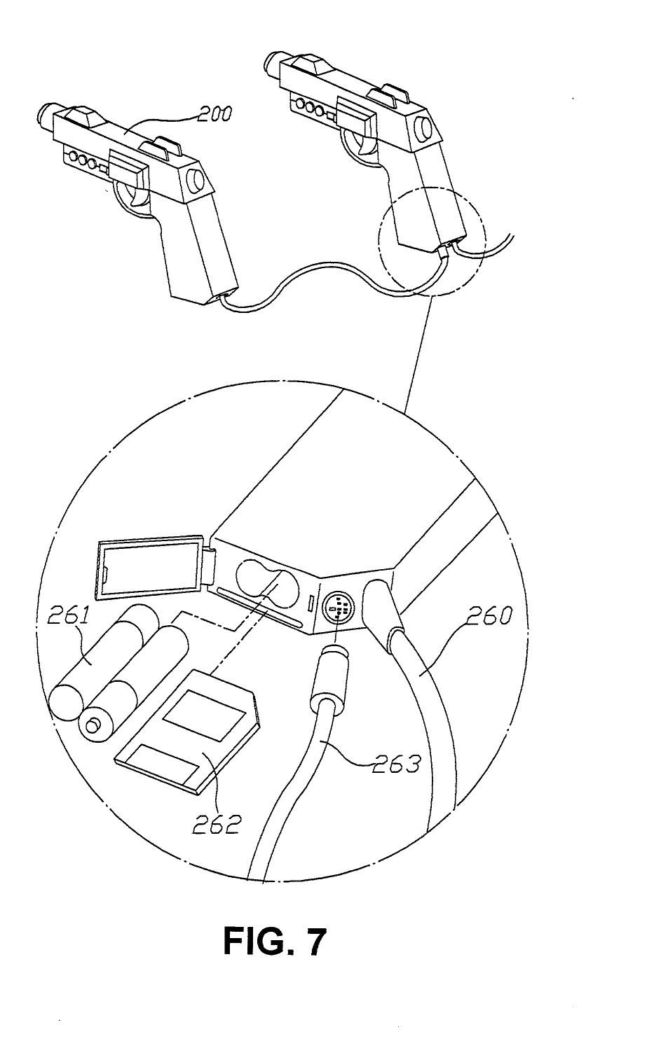

Referring to FIG. 7 which shows another preferred embodiment of the present invention, wherein, not only the gun stock can have a power line 260 used to supply power, but also an additional battery set 261 is provided in cooperating with an extension groove and its component 262 to allow an extension line 263 to connect by insertion with another gun type main machine 200 for games for two.

Accordingly, the game equipment of the present invention can control electric games only with a single light gun to thereby save using a conventional large main game machine. A manufacturer can largely reduce the volume of packaging after production of the game equipment, and space for storage, placing for a seller as well as for a user can be reduced too. Having now particularly described and ascertained the nature of our said invention which is industrially valuable and in what manner the same is to be performed, we declare that what we claim are:

1. A gun type main game machine, said machine comprises a light gun connecting with an image, sound and power line, said light gun includes a plurality of externally provided operating buttons and a power switch, and is mounted therein in pursuance of the shape thereof a main electric circuit board for games, said main electric circuit board is provided with a single chip microprocessor, a microswitch, a plurality of light emitting diodes and a photoelectric diode; the shank of said light gun is provided with an exposed trigger for controlling said microswitch to activate said photoelectric diode to thereby eject light beam out of the muzzle of said light gun.

2. A gun type main game machine as defined in claim 1, wherein, said light gun connects a power supply and a displaying device through said image, sound and power line provided externally of said light gun.

3. A gun type main game machine as defined in claim 1, wherein, said light gun has a battery to get electric power.

4. A gun type main game machine as defined in claim 1, wherein, said trigger has a backwardly movable triggering end and an inner moving end, said microswitch is located at a place slightly above said moving end for controlling by moving.

5. A gun type main game machine as defined in claim 1, wherein, said light gun is provided therein near the stock thereof with an extension groove containing a connecting means.

6. A gun type main game machine as defined in claim 1, wherein, said photoelectric diode of said main electric circuit board is provided on the front end thereof with a light guiding shade, and is provided on the front end of said light guiding shade with a lens near said gun muzzle.

7. A gun type main game machine as defined in claim 5, wherein, another gun type main machine with an extension line is provided to connect by insertion with said gun stock.
